(19) United States
(12) Patent Application Publication
(10) Pub. No.: US 2013/0292066 A1
(43) Pub. Date: Nov. 7, 2013

(54) WINDOW COVERING SYSTEM WITH MAGNETIC POSITIONING

(71) Applicant: Dana Draper, Phoenix, AZ (US)

(72) Inventor: Dana Draper, Phoenix, AZ (US)

(73) Assignee: Biltmore Shutters, Inc.

(21) Appl. No.: 13/465,285

(22) Filed: May 7, 2012

(51) Int. Cl. E06B 9/322

(52) U.S. Cl. 160/107; 160/168.1 P; 160/405

(57) ABSTRACT

A window covering system with selectively positionable slats and a plurality of strategically positioned pairs of cooperating magnets. At least one magnet is embedded in or otherwise attached to predetermined locations on both the frame and the slats of the window covering. By aligning the magnets in the slats with the magnets in the frame, the slats can be quickly, reliably, and uniformly set to one or more desired positions.

### BACKGROUND OF THE INVENTION

1. Field of the Invention

The present invention relates generally to the field of window coverings and more specifically relates to the positioning of a window covering.

2. Related Art

Most homes and commercial buildings incorporate windows as a way to allow natural light to illuminate the interior space of the home or building. The introduction of natural light is generally viewed as a desirable aspect of an enjoyable and well-designed interior environment. Additionally, the use of windows allows for occupants of the building to view the surroundings located outside the building, including any scenery that may be present. This can add to the overall enjoyment of the structure as the occupants can appreciate the natural light and views available through the windows.

However, there are often times when it is desirable to have the windows covered, to prevent light from entering the structure and to prevent individuals on the outside from peering into the building from the exterior. For example, whenever privacy is desired, or during the evening hours, most people will cover the windows with some type of window covering to prevent passersby from viewing the interior of their home or building and to keep unwanted light from entering the structure. This has led to the development of many different approaches that can be used to selectively and temporarily cover the windows of a home or business.

For example, a wide variety of coverings such as venetian blinds, plantation shutters, curtains, vertical blinds, etc. have been developed and deployed to provide temporary cover for windows. Venetian blinds and plantation shutters generally employ a plurality of horizontal “louvers” or “slats” that can be selectively positioned in various orientations, including the “open” position so as to allow light to enter through the window or in the “closed” position, thereby covering the window so as to prevent light from entering the window. Interim positions are also possible. Similarly, vertical blinds employ a plurality of vertical “louvers” or “slats” that can be selectively positioned as desired to control the amount of light that enters through a window. Curtains are simply large pieces of material that can be selectively positioned over the window, thereby allowing the building occupants to determine when, and how much, light can enter through the window.

While various window coverings have been adopted with varying levels of success, present window coverings have certain limitations. For example, most venetian blinds and vertical blinds comprise a rotatable “wand” or pull chain/rope mechanism that can be used to adjust the angle of the slats in the window covering. However, this takes time and, where uniformity for the positioning of the slats in a number of different windows is desired, may take some trial and error. Plantation shutters, while providing an enhanced ability to quickly and accurately position the slats in the open or closed position, lack the ability to accurately provide uniformity of slat positions as well. Accordingly, without additional improvements in the variety and operation of window coverings, the ability to control and adapt the window covering to achieve the desired lighting effect will continue to be sub-optimal.

### BRIEF SUMMARY OF THE INVENTION

A window covering system with selectively positionable slats and a plurality of strategically positioned pairs of cooperating magnets. At least one magnet is embedded in or otherwise attached to predetermined locations on both the frame and the slats of the window covering. By aligning the magnets in the slats with the magnets in the frame, the slats can be quickly, reliably, and uniformly set to one or more desired positions.

### BRIEF DESCRIPTION OF THE SEVERAL VIEWS OF THE DRAWINGS

The preferred embodiments of the present invention will hereinafter be described in conjunction with the appended drawings, wherein like designations denote like elements, and:

FIG. 1 is a schematic drawing of a window covering system with cooperating magnets in accordance with a preferred exemplary embodiment of the present invention;

FIG. 2 is a schematic drawing of a side view of a window covering system with cooperating magnets in accordance with a preferred exemplary embodiment of the present invention;

FIG. 3 is a schematic drawing of magnets suitable for use in a window covering system with cooperating magnets in accordance with a preferred exemplary embodiment of the present invention; and

FIG. 4 is a schematic representation of the operation of a window covering system with cooperating magnets in accordance with a preferred exemplary embodiment of the present invention.

### DETAILED DESCRIPTION OF THE INVENTION

A window covering system with selectively positionable slats and a plurality of strategically positioned pairs of cooperating magnets. At least one magnet is embedded in or otherwise attached to predetermined locations on both the frame and the slats of the window covering. By aligning the magnets in the slats with the magnets in the frame, the slats can be quickly, reliably, and uniformly set to one or more desired positions.

In the most preferred embodiments of the present invention, the window covering system is based on a standard plantation shutter window covering that has been modified as disclosed herein. In the standard plantation shutter window covering, there are a plurality of horizontally positioned relatively flat and rectangular “slats” or “louvers” of uniform size that are spaced equidistant from each other. These slats are pivotably fixed in position in a frame. There is also a vertical adjustment bar that is pivotably attached to the front each of the slats. Since the adjustment bar is attached to each of the slats, any movement of the adjustment bar in a vertical direction (up or down) causes all of the slats to pivot about a pivot point and be positioned in a substantially identical orientation, relative to each other and the frame of the plantation shutter window covering.

By grasping the adjustment bar with your hand, and moving it upwards or downwards in a vertical direction, the position of the individual slats can be adjusted in unison. If the adjustment bar is moved to the extreme upward or extreme downward position, the slats will be placed in a substantially vertical orientation, thereby effectively blocking all or substantially all of the window opening. By positioning the adjustment bar in a position approximately midway between the extreme, positions, the slats are positioned so as to be substantially parallel to each other and floor of the room, thereby permitting the maximum amount of light to enter the room. Accordingly, by moving the adjustment bar and positioning the slats at various positions, the amount of light entering the room through the window can be adjusted to the desired level. For purposes of discussion, the term “affixed to” means attached to a surface of the frame or the slats or embedded beneath the surface of the frame or the slats.

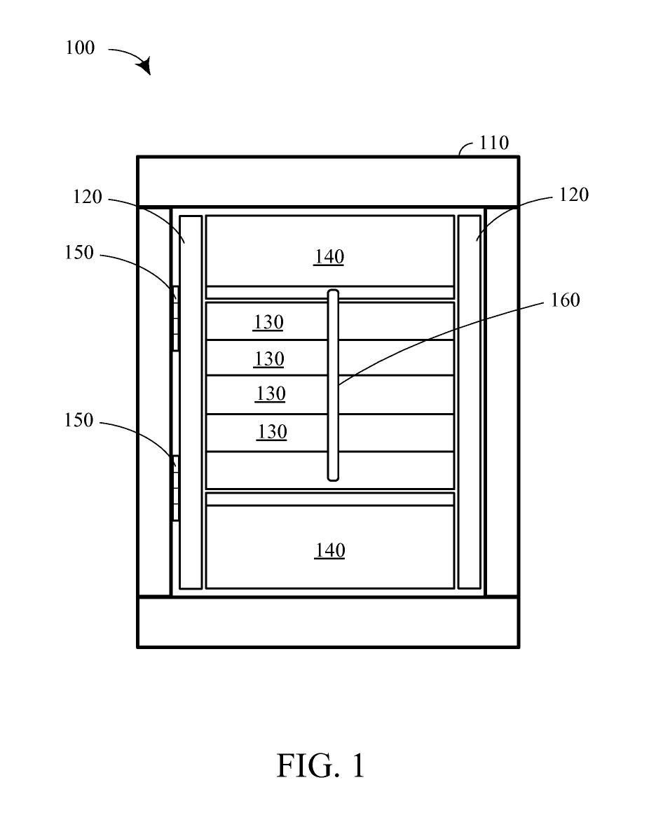

Referring now to FIG. 1, a schematic drawing of a window with a window covering system in accordance with a preferred exemplary embodiment of the present invention is depicted. As shown in FIG. 1, window 100 has a plantation shutter covering installed in window frame 110. The window covering system comprises: a pair of side rails 120; a pair of headers 140; a plurality of slats 130; and an adjustment bar 160. Rails 120 and headers 140 define a perimeter for window 100. The window covering system is installed in frame 110 by a pair of hinges 150. Hinges 150 provide a way for the window covering system to be rotated away from the window, thereby allow the light from the exterior of the window to enter through the window and also providing for access to the window for cleaning and other purposes. In addition to the standard elements shown in FIG. 1, the window covering system also incorporates one or more pairs of cooperating magnets (not visible this FIG.) that can be used to quickly and easily adjust the position of slats 130 to any number of predetermined positions.

It should be noted that the window covering system shown in FIG. 1 is merely one example or embodiment of the window covering systems contemplated by the present invention. In some cases, the number of slats 130 can be increased by a significant number. Additionally, the number of hinges 150 may be more or less than shown in FIG. 1. Further, in some applications, there will be multiple panels of slats 130, with hinges 150 attached to both of the side rails 120, allowing the panels to be rotated outwards and away from the center.

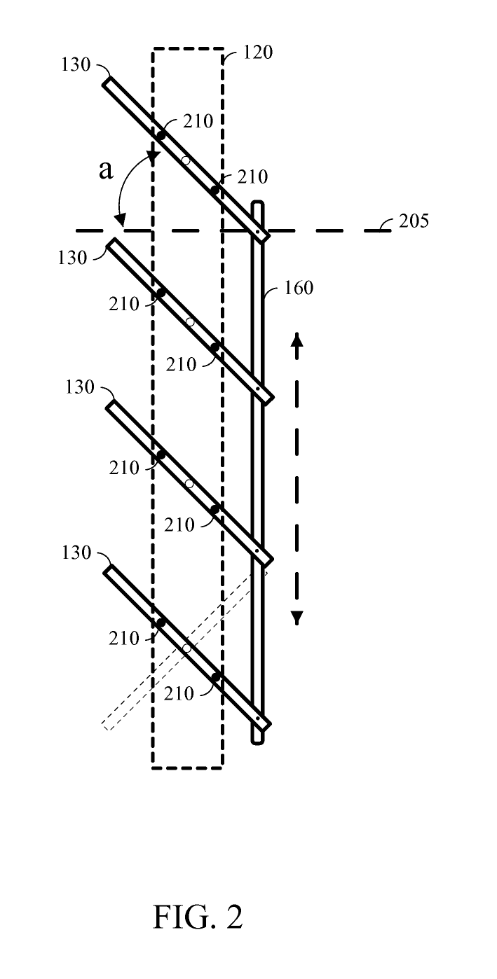

Referring now to FIG. 2, a side view of a window covering system in accordance with a preferred embodiment of the present invention is depicted. As shown in FIG. 2, angle “a” represents the angle formed between each of slats 130 and a horizontal plane 205. As slats 130 are repositioned, angle “a” can vary from approximately +90° to approximately −90°, with plane 205 representing 0°. In both of the extreme positions, slats 130 effectively cover the window and prevent light from entering through the window. When angle “a” is at or near 0°, slats 130 are substantially parallel to plane 205, the ceiling, and floor of the room where the window is installed.

Additionally, as shown in FIG. 2, adjustment bar 160 is attached to each of slats 130 and, by moving adjustment bar 160 upwards or downwards, each of slats 130 will move in unison, where each of slats 130 remains substantially parallel to each other slat 130, and slats 130 can be positioned as desired.

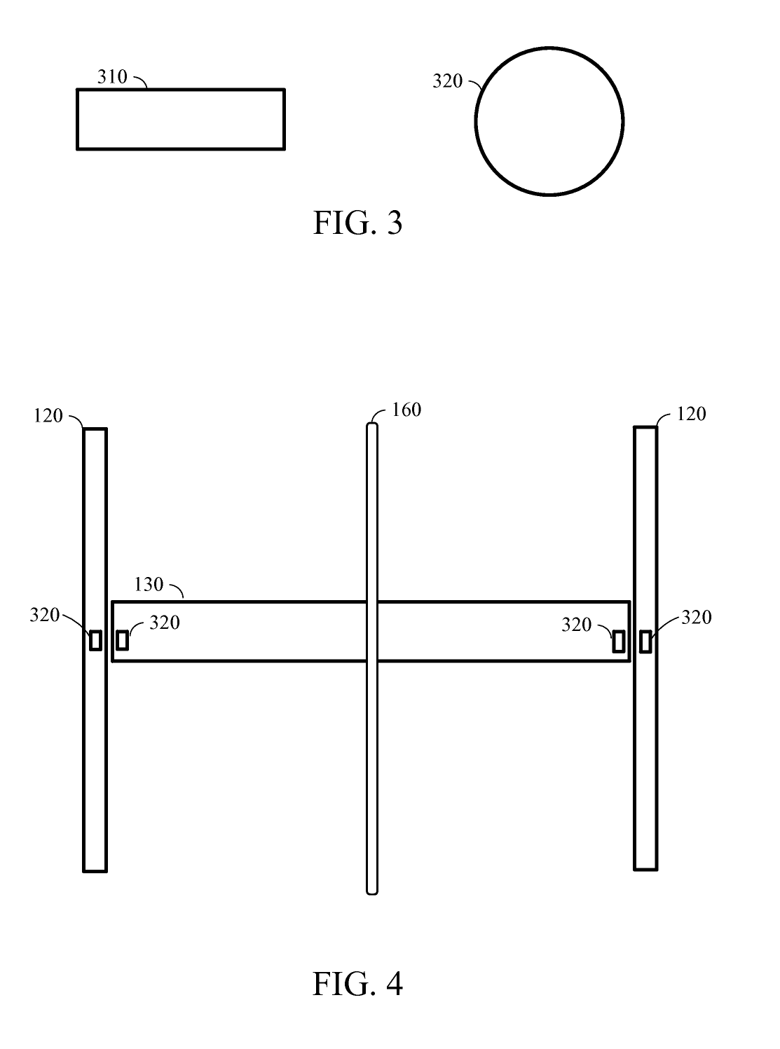

Referring now to FIG. 3, a magnet 310 and a magnet 320, suitable for use in one or more preferred embodiments of the present invention are shown. Magnet 310 is substantially rectangular in shape while magnet 320 is substantially circular in shape. Other shapes of magnets may be deployed as well. In any case, regardless of the shape, the magnets will typically be deployed in pairs, with a magnet affixed to or embedded in a slat cooperating with a magnet embedded in or affixed to the perimeter of the frame. By positioning the magnet in the frame in the proper position, when the magnet in the slat is positioned in proximity to the magnet in the frame, the magnetic attraction between the magnets will “attract” the slat to the pre-determined position and basically “snap” or “lock” the slat into the desired pre-determined position, due to the magnetic attraction. By moving the adjustment bar up or down, it would be possible to overcome the initial magnetic attraction and reposition the slats to a different position.

The number of magnets used, the size of the magnets, the strength of the magnets, and the positioning of the magnets, will be determined by the specific applications. Larger windows, with larger slats, will require larger magnets. It is not necessary to have a magnet associated with each slat, but it may be desirable to ensure the most effective magnetic positioning of the slats. For example, in the most preferred embodiments of the present invention, there will be a plurality of magnets in both the slats and the frame. In this application, there may be a pair of magnets in the frame that would attract the slats to a substantially closed position, both upwards and downwards. Additionally, there may be magnets positioned in the frame so as to attract the slats to the position where the angle with the horizontal plane depicted in FIG. 2 is +/−30° or +/−60° as well as the +/−45° position. In this fashion, there are multiple pre-determined positions available for positioning the slats in a given window covering system.

Referring now to FIG. 4, a schematic view of a single slat 130, and magnets 320, are shown in a typical installation. As shown in FIG. 4, magnets 320 are embedded in both slat 130 and side rails 120. As adjustment bar 160 is moved in the vertical direction, the magnets 320 in slat 130 will eventually be aligned with the magnets 320 in side rails 120. At that time, the magnetic attraction between the magnets 320 in slat 130 and magnets 320 in side rails 120, thereby fixing slat 130 in the desired pre-determined position. By including additional magnets in other slats 130, and by placing additional magnets 320 in alternative locations in side rails 120, multiple magnetic positioning locations can be included. This allows for the efficient and precise positioning of multiple slats 130 in multiple window covering systems. So, for example, if a plurality of windows were placed in an exterior wall, with a window covering system as described herein installed for each of the windows, it would be possible to quickly, uniformly, and precisely adjust all of the slats 130 to a desired pre-determined position.

In summary, the present invention teaches a window covering system with selectively positionable or repositionable slats comprises a plurality of strategically positioned cooperating magnets. The magnets are affixed to, embedded in or otherwise attached to predetermined locations on both the slats of the window covering and the frame or housing for the slats. By aligning the magnets in the slats with the magnets in the frame, the slats can be quickly, reliably, and uniformly set to the desired position or positions.

From the foregoing description, it should be appreciated that window covering system disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A window covering system comprising:
a frame;
a plurality of movable slats mounted in the frame; and
a least one pair of cooperating magnets, where a first magnet from the at least one pair of cooperating magnets is affixed to the frame and a second magnet from the at least one pair of the cooperating magnets is affixed to at least one of the plurality of movable slats.

2. The window covering system of claim 1 further comprising an adjustment bar attached to each of the plurality of slats.

3. The window covering system of claim 1 wherein the at least one pair of cooperating magnets comprises a plurality of pairs of cooperating magnets.

4. The window covering system of claim 1 wherein the at least one paid of cooperating magnets comprises at least two pairs of cooperating magnets.

5. The window covering system of claim 1 wherein the frame comprises a pair of side rails and a header and wherein the first magnet is embedded in one of the side rails and the second magnet is embedded din the at least one of the plurality of movable slats.

6. The window covering system of claim 1 wherein the frame comprises a pair of side rails and a header and wherein the first magnet is embedded in one of the side rails and the second magnet is embedded din the at least one of the plurality of movable slats and further comprising an adjustment bar attached to each of the plurality of slats.

7. The window covering system of claim 1 wherein the at least one pair of cooperating magnets comprises a plurality of pairs of cooperating magnets and wherein the frame comprises a pair of side rails and further comprising:
a first magnet from each of the pairs of cooperating magnets is embedded in a side rail; and
a second magnet from each of the pairs of cooperating magnets is embedded in each of the plurality of movable slats

8. The window covering system of claim 1 wherein the window covering system is positioned to cover a window.

9. The window covering system of claim 1 further comprising:
a plurality of windows, wherein each of the plurality of windows comprises:
a pair of side rails, with a plurality of side rail magnets being embedded in each of the side rails; and
a header; and
a plurality of window covering systems covering each of the plurality of windows, wherein each of the plurality of window covering systems comprises:
a plurality of moveable slats: and
at least one magnet embedded in each of the plurality of moveable slats.

10. A method of positioning movable slats comprising the steps of:
mounting at least a first magnet in at least one moveable slat of a window covering;
mounting at least a second magnet in a window frame, the window covering being mounted in the window frame; and
aligning the at least a first magnet with the at least a second magnet, thereby fixing the movable slat in a predetermined position relative to the window frame.

11. The method of claim 10 further comprising the step of aligning the at least a first magnet with a third magnet, the third magnet being mounted in the window frame.

12. The method of claim 10 wherein the at least a first magnet comprises a plurality of magnets.

13. The method of claim 10 wherein the at least a second magnet comprises a plurality of magnets.

14. The method of claim 10 wherein the at least a first magnet comprises a first plurality of magnets and wherein the at least a second magnet comprises a second plurality of magnets.

15. The method of claim 10 wherein the at least one moveable slat comprises a plurality of selectively repositionable slats and further comprising an adjustment bar attached to each of the plurality of selectively repositionable slats.

16. The method of claim 10 wherein the window frame comprises a pair of side rails and the at least a second magnet comprises at least one window frame magnet embedded in one of the side rails.

17. The method of claim 10 wherein the window frame comprises a pair of side rails and the at least a second magnet comprises at least one window frame magnet embedded in each of the side rails.

18. A window covering system comprising:
a window frame, the window frame comprising a pair of side rails;
a plurality of window frame magnets embedded in each of the paid of side rails;
a plurality of selectively repositionable slats mounted in the window frame;
an adjustment bar affixed to the plurality of selectively repositionable slats mounted in the window frame; and
at least one magnet embedded in each of the selectively repositionable slats mounted in the window frame.
